(19) United States
(12) Patent Application Publication
(10) Pub. No.: US 2007/0130195 A1
(43) Pub. Date: Jun. 7, 2007

(54) Modeling enumeration tables for relational databases

(76) Inventors: Xiang Li, Redmond, WA (US); Lawrence Eugene Dunnell, Redmond, WA (US); Hong-Lee Yu, Woodinville, WA (US); Gao Yi, Redmond, WA (US)

Correspondence Address: KONRAD RAYNES & VICTOR, LLP;ATTN: IBM54, 315 SOUTH BEVERLY DRIVE, SUITE 210, BEVERLY HILLS, CA, 90212, US

(21) Appl. No.: 11/295,942

(22) Filed: Dec. 6, 2005

(51) Int. Cl. G06F 7/00

(52) U.S. Cl. 707/102

(57) ABSTRACT

Provided are method, system, and article of manufacture, wherein a table is determined to be an enumeration table, in response to an indication provided to an application. Metadata corresponding to rows and columns of the enumeration table is generated. A model that logically represents the enumeration table by storing the generated metadata is maintained.

### BACKGROUND

1. Field

The disclosure relates to a method, system, and article of manufacture for the modeling of enumeration tables for relational databases.

2. Background

Modeling software may be used to model applications or data. For example, certain object oriented modeling tools, such as the IBM* Rational* Software Modeler, may use classes and objects to logically model source code implementations of applications. A logical model of an application may represent the logical flow, the data structures, and the interrelationships among the data structures of an application.

A database is a collection of data elements, such that a computer program can be used to query the database to extract information. A relational database is a type of database that includes a collection of tables, where each table includes a set of rows and columns. Computer programs written in languages, such as, structured query language (SQL), may be used to create, retrieve and update data stored in a relational database. Database modeling tools may be used to logically model relational databases, where the relational databases may have been implemented in database management systems known in the art, such as DB2*, SQL server, etc.

Certain database modeling tools may provide a user interface that may be used by a user to interact with the database modeling tools. Such database modeling tools may be referred to as visual database modeling tools. In a visual database modeling tool, the user may select various indicators from the user interface to perform different actions on the logical models of the databases.

Certain database management systems may use data structures, such as tables, to store data. Some visual database modeling tools can assist a user in the design and maintenance of the tables of a database. Certain visual database modeling tools may also use a modeled database to automatically generate tables and code corresponding to database management systems known in the art. For example, SQL scripts may be used to generate a database. The visual database modeling tool can also be used to read an existing database definition into a database model.

Certain database modeling tools may perform a two-level modeling that comprises logical data modeling and physical data modeling. Logical data modeling is database independent and may include constructs such as entities, attributes, relationships, subtype-super-types, etc. Physical data modeling is database dependent and may include constructs, such as, tables, columns, constraints, triggers, indexes, etc. Database modeling tools may allow users to perform different actions on the logical models of the tables. Certain database modeling tools may model the fields, i.e., the columns, of a database table.

### SUMMARY OF THE DESCRIBED EMBODIMENTS

Provided are method, system, and article of manufacture, wherein a table is determined to be an enumeration table, in response to an indication provided to an application. Metadata corresponding to rows and columns of the enumeration table is generated. A model that logically represents the enumeration table by storing the generated metadata is maintained.

In certain embodiments, the rows of the enumeration table are fixed in number.

In additional embodiments, the application is a visual database modeling tool, and the determining of the table, the generating of the metadata, and the maintaining of the model, are performed by the visual database modeling tool.

In further embodiments, the indication is provided by a user to the visual database modeling tool by selecting an indicator that indicates a type of the table.

In still further embodiments, the rows of the enumeration table correspond to instances, wherein the columns of the enumeration table are predetermined in number.

In additional embodiments, an indicator is provided in the visual database modeling tool, wherein the indicator is selected to insert additional rows into the modeled enumeration table.

In yet additional embodiments, an indicator is provided in the visual database modeling tool, wherein the indicator is selected to generate instances of the enumeration table from the modeled rows and columns of the enumeration table.

In further embodiments, a comparison is made of the model of the enumeration table stored in the visual database modeling tool to an instance of the enumeration table stored in a database. The model is synchronized with the instance, in response to a change in the instance of the enumeration table that has been modeled by the visual database modeling tool.

### BRIEF DESCRIPTION OF THE DRAWINGS

Referring now to the drawings in which like reference numbers represent corresponding parts throughout:

FIG. 1 illustrates a block diagram of a computing environment in accordance with certain embodiments;

FIG. 2 illustrates a first exemplary database including enumeration tables implemented in the computing environment of FIG. 1, in accordance with certain embodiments;

FIG. 3 illustrates a second exemplary database including enumeration tables implemented in the computing environment of FIG. 1, in accordance with certain embodiments;

FIG. 4 illustrates a flowchart for modeling enumeration tables and other tables in a database, in accordance with certain embodiments;

FIG. 5 illustrates exemplary metadata generated by modeling enumeration tables and other tables in a database, in accordance with certain embodiments;

FIG. 6 illustrates a flowchart for inserting additional rows in the model of an enumeration table, in accordance with certain embodiments;

FIG. 7 illustrates certain indicators displayed by a visual database modeling tool, in accordance with certain embodiments;

FIG. 8 illustrates certain exemplary user interfaces, in accordance with certain embodiments;

FIG. 9 illustrates a block diagram that includes an additional exemplary user interface for generating exemplary data definition language code, in accordance with certain embodiments; and

FIG. 10 illustrates the architecture of computing system, wherein in certain embodiments the computational platform of the computing environment of FIG. 1 may be implemented in accordance with the architecture of the computing system.

### DETAILED DESCRIPTION

In the following description, reference is made to the accompanying drawings which form a part hereof and which illustrate several embodiments. It is understood that other embodiments may be utilized and structural and operational changes may be made.

An enumeration table is a database table that has a fixed number of rows. Content associated with the enumeration table may be manipulated via software applications written by developers. While end users may manipulate the content associated with tables that are not enumeration tables, the end users may not directly manipulate the content associated with enumeration tables. The fixed number of rows of an enumeration table may be set prior to deployment of the database. The entries of the enumeration table are constant values. Additionally, in many databases the columns of a database table are relatively fewer in number in comparison to the rows of the database table, where the rows store the instances, i.e., the data. Certain embodiments enable both rows and columns of database tables that are enumeration tables to be modeled by a database modeling tool.

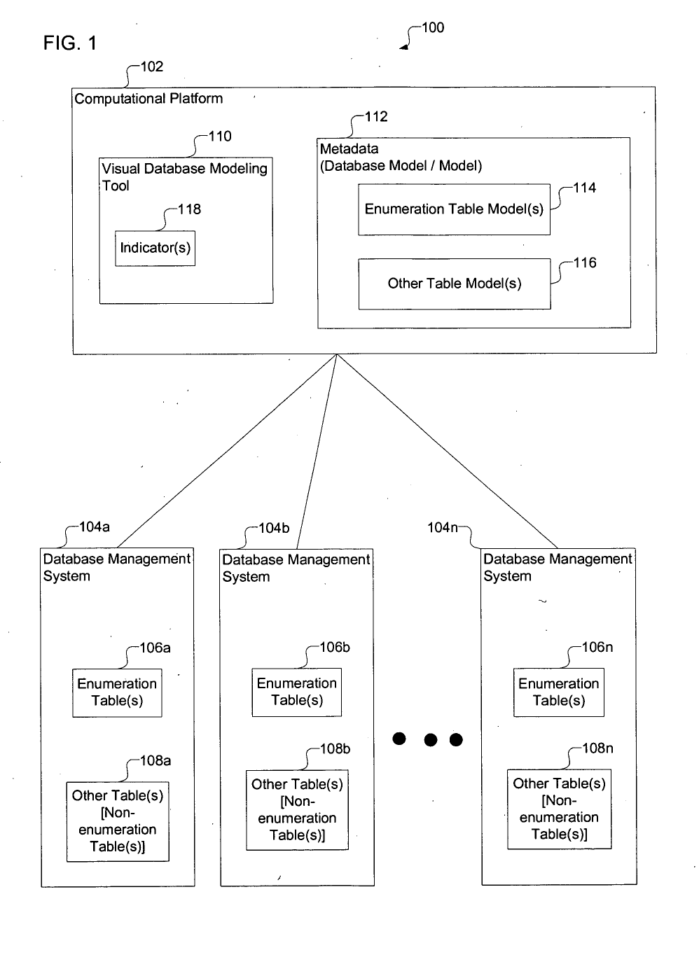

FIG. 1 illustrates a block diagram of a computing environment 100 in accordance with certain embodiments. At least one computational platform 102 may be coupled to one or more database management systems 104a, 104b, . . . 104n. The coupling of the computational platform 102 to the database management systems 104a . . . 104n may be direct or may be via any network known in the art, such as a Storage Area Network (SAN), Local Area Network (LAN), Wide Area Network (WAN), the Internet, an Intranet, etc. In certain embodiments, the database management systems 104a . . . 104n may be implemented in computational platforms that are different from the computational platform 102. In alternative embodiments, the database management systems 104a . . . 104n may be implemented within the computational platform 102.

The computational platform 102 may comprise any suitable computational platform, including those presently known in the art, such as, personal computers, workstations, mainframes, midrange computers, network appliances, palm top computers, telephony devices, blade computers, laptop computers, etc.

The database management systems 104a . . . 104n may comprise any suitable database management system, including those presently known in the art, such as, DB2, SQL server, etc. The database management systems 104a . . . 104n implement databases that include a plurality of enumeration tables 106a, 106b, . . . ,106n and a plurality of other tables 108a, 108b, . . . , 108n that are not enumeration tables. The tables 108a . . . 108n that are not enumeration tables may also be referred to as non-enumeration tables. For example, the database management system 104a may include in a database one or more enumeration tables 106a and one or more non-enumeration tables 108a.

The computational platform 102 includes a visual database modeling tool 110 and metadata 112, i.e., information about data, where the metadata 112 may model data stored in one or more database management systems 104a . . . 104n. The metadata 112 may also be referred to as a database model or a model. The visual database modeling tool 110 may comprise an application implemented in software, firmware, hardware or any combination thereof.

The database model 112 may include one more enumeration table models 114 and one or more other table models 116. The enumeration table models 114 may logically represent, i.e., model, one more enumeration tables 106a . . . 106n, and the other table models 116 may logically represent, i.e., model, one or more other tables 108a . . . 108n.

The visual database modeling tool 110 includes one or more indicators 118 that may be selected or otherwise manipulated by a user via a user interface provided by the visual database modeling tool 110. The indicator 118 may be implemented by any suitable data structure presently known in the art, such as, a menu, a list, selection controls, etc. The metadata 112 may be created, maintained, and updated by a user by selecting or otherwise interacting with the indicators 118.

FIG. 1 illustrates certain embodiments in which a visual database modeling tool 110 is used to create, maintain, and update a database model 112, where the database model 112 includes enumeration table models 114 that model enumeration tables 106a . . . 106n, and other table models 116 that model non-enumeration tables 108a . . . 108n.

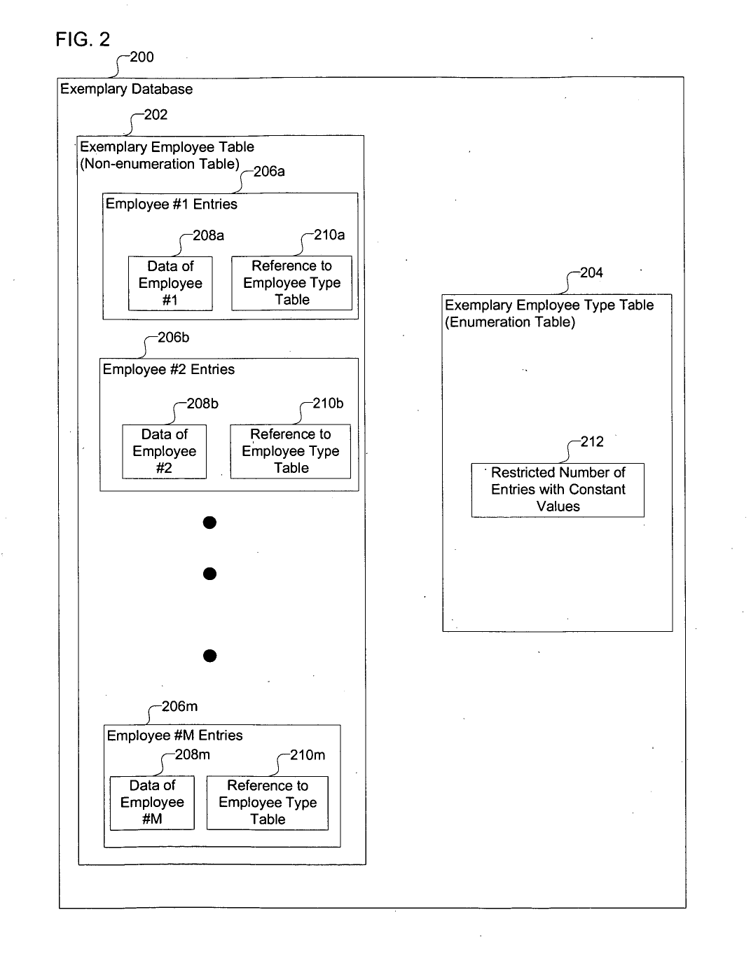

FIG. 2 illustrates a first exemplary database 200 including exemplary enumeration tables implemented in the computing environment 100 of FIG. 1, in accordance with certain embodiments. The exemplary database 200 may be implemented in any of the database management systems 104a . . . 104n shown in FIG. 1.

The exemplary database 200 many include an exemplary employee table 202 and an exemplary employee type table 204, where the exemplary employee table 202 is a non-enumeration table and the exemplary employee type table 204 is an enumeration table.

The exemplary employee table 202 includes entries for each employee of a business. For example, the exemplary employee table 202 may include exemplary employee entries 206a, 206b, . . . ,206m, where the number of exemplary employee entries 206a . . . 206m may in certain exemplary embodiments exceed several thousand. The exemplary employee entries 206a . . . 206m may include fields corresponding to the data 208a, 208b, . . . ,208m of the employees and may also include references 210a, 210b, . . . 210m to the employee type table 204. In certain alternative embodiments, the exemplary employee table 202 may be structured differently. For example, the references 210a . . . 210m may be structured in a different matter within the exemplary employee table 202.

The exemplary employee type table 204 includes entries 212 with constant values, where the entries are restricted in number. For example, several thousand employees may be categorized into three employee types, e.g., executive employee, manager employee, non-management employee.

The exemplary employee table 202 is a non-enumeration table because the number of employee entries 206a . . . 206n is not predetermined. The exemplary employee table 204 is an enumeration table because the number of employee types is predetermined, and each employee type may be represented by a constant value.

In certain embodiments, the visual database modeling tool 110 generates a logical representation of the exemplary employee type table 204 in the enumeration table model 114, and generates a logical representation of the exemplary employee table 202 in the other table model 116.

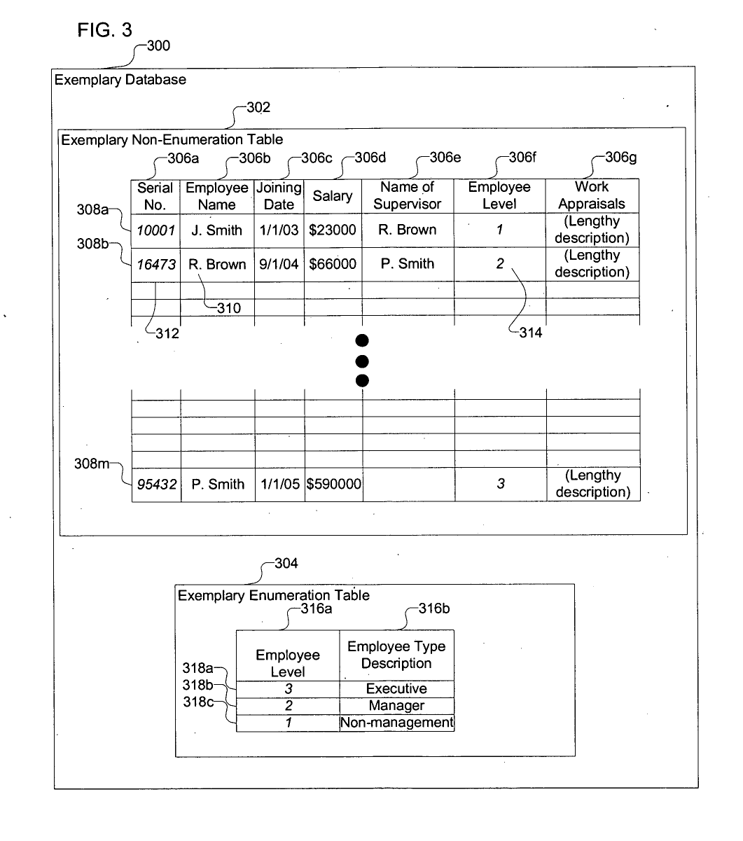

FIG. 3 illustrates a second exemplary database 300 including enumeration tables implemented in the computing environment 100 of FIG. 1, in accordance with certain embodiments. The exemplary database 300 may be implemented in any of the database management systems 104a . . . 104n shown in FIG. 1. In certain embodiments, the exemplary database 300 may also be an implementation of the exemplary database 200 shown in FIG. 2.

The exemplary database 300 includes an exemplary non-enumeration table 302 and an exemplary enumeration table 304, where the exemplary non-enumeration table 302 may be an implementation of the exemplary employee table 202 of FIG. 2, and the exemplary enumeration table 304 may be an implementation of the exemplary employee type table 204 of FIG. 2.

The exemplary non-enumeration table 302 may include columns representing fields of employee data, such as serial number 306a, employee name 306b, joining date 306c, salary 306d, name of supervisor 306e, employee level 306f, and work appraisals 306g. The rows 308a, 308b, . . . ,308m of the exemplary non-enumeration table 302 represent employee data, where the rows of the non-enumeration table 302 may also be referred to as including instances of employee data. For example, row 308b includes data for an employee named R. Brown 310 with serial number 16473 (reference numeral 312), where the employee level of the employee is level 2 (reference numeral 314). The entries in the rows corresponding to the work appraisal column 306g may include a lengthy description of the employee's performance in various positions.

There are an unrestricted number of rows corresponding to employees in the exemplary non-enumeration table 302. In addition, certain columns such as the work appraisal 306g column may allow the entry of data whose length is not limited.

The exemplary enumeration table 304 includes two columns representing employee level 316a and employee type description 316b. In certain embodiments, the employee, level 316a can be 1, 2, or 3 and the corresponding employee type description 316b can be “Executive”, “Manager”, and “Non-management” respectively. Therefore, the rows 318a, 318b, 318c of the exemplary enumeration table 304 are three in number and the entries of the exemplary enumeration table 304 are constant values.

Entries in the exemplary non-enumeration table 302 may be used to reference the enumeration table 304. For example, the entries of the employee level 306f column in the exemplary non-enumeration table 302 can be used to reference the exemplary enumeration table 304. In alternative embodiments, the referencing of the enumeration table 304 may be performed differently from the non-enumeration table 302.

Therefore, FIG. 3 illustrates certain embodiments in which an exemplary enumeration table 304 has a well-defined (e.g., three rows, two columns), reasonably-sized set of constant values (e.g., 1, 2, 3, “Executive”, “Manager”, “non-Management”). In the exemplary non-enumeration table 302 the number of columns is well-defined (e.g., seven columns) but the number of rows is not well-defined as the number of employees is not predefined. Furthermore, certain entries, such as those for work appraisals 306f are not constant values. In certain embodiments the visual database modeling tool 110 models the rows and columns of the enumeration table 304 in the metadata 112, and models the columns of the non-enumeration table 302 in the metadata 112. Since the rows, i.e., instances, of the enumeration table 304 are well-defined and have constant values, such rows are modeled by the visual database modeling tool 110. However since the rows, i.e., instances, of the non-enumeration table 302 are not well-defined and may include values that are not constants, such rows are not modeled by the visual database modeling tool 10.

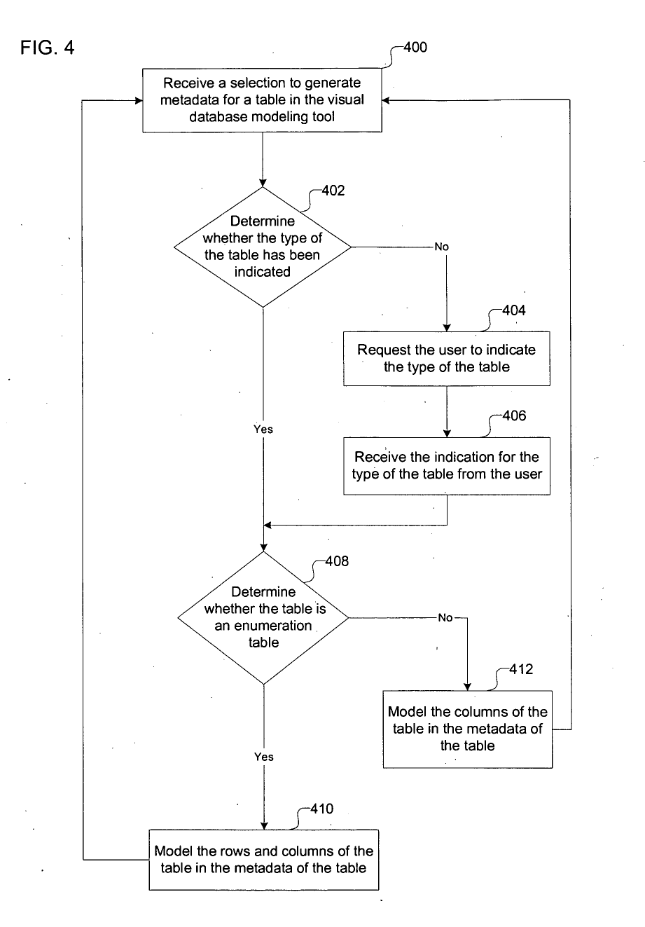

FIG. 4 illustrates a flowchart for modeling enumeration tables 106a . . . 106n and other tables 108a . . . 108n of a database implemented in database management systems 104a . . . 104n, in accordance with certain embodiments. The operations described in the flowchart of FIG. 4 may be implemented in the visual database modeling tool 110 within the computational platform 102.

Control starts at block 400, where the visual database modeling tool 10 receives a selection to generate metadata 112 for a table. The selection may be made by a user by interacting with an indicator 118 that has been displayed on a computer display coupled to the computational platform 102. For example, an indicator 118 may include an indicator that when selected initiates the process of generating metadata for a table. The table may be implemented in any of the database management systems 104a . . . 104n.

The visual database modeling tool 110 determines (at block 402) whether the type of the table has been indicated. For example, in certain embodiments the type of the table may have been indicated previously by a user or the type of the table may be indicated in some data structure associated with the table.

If the visual database modeling tool 110 determines (at block 402) that the type of the table has not been indicated then the visual database modeling tool 110 may request (at block 404) the user to indicate the type of the table. The request may be displayed to the user via a message in a user interface with which the user interacts. The visual database modeling tool 110 receives (at block 406) the indication that indicates the type of the table from the user. In certain embodiments, the user may manually select a table to be either an enumeration table or a non-enumeration table. Control proceeds to block 408.

If the visual database modeling tool 110 determines (at block 402) that the type of the table has been indicated, or the visual database modeling tool 110 receives (at block 406) the indication that indicates the type of the table from the user, then the visual database modeling tool 110 determines (at block 408) whether the table is an enumeration table 408. If so, then the visual database modeling tool 110 models (at block 410) the rows and column of the table in the metadata 112 of the table and control returns to block 400 where a new selection may be received to generate metadata 112 for another table. In certain alternative embodiments, a single selection may generate metadata 112 for a plurality of tables, where the plurality of tables may be implemented in different database management systems.

If the visual database modeling tool 110 determines (at block 408) that the table is not an enumeration table, then the visual database modeling tool 110 models (at block 412) the columns of the table in the metadata 112 of the table. The rows of the table are not modeled because the instances of a non-enumeration table are not well-defined and may not include a reasonably-sized set of constant values. Control proceeds to block 400 for generating models of additional tables. The modeling of the rows and/or columns results in the generation of the metadata 112 of the table.

Therefore, FIG. 4 illustrates certain embodiments in which the visual database modeling tool 110 determines a table to be an enumeration table, in response to an indication provided to the visual database modeling tool 110. The indication to the visual database modeling tool 110 may be provided via a selection from a user, via a computer program or via other mechanisms. The visual database modeling tool generates metadata corresponding to rows and columns of the enumeration table and maintains a model that logically represents the enumeration table by storing the generated metadata.

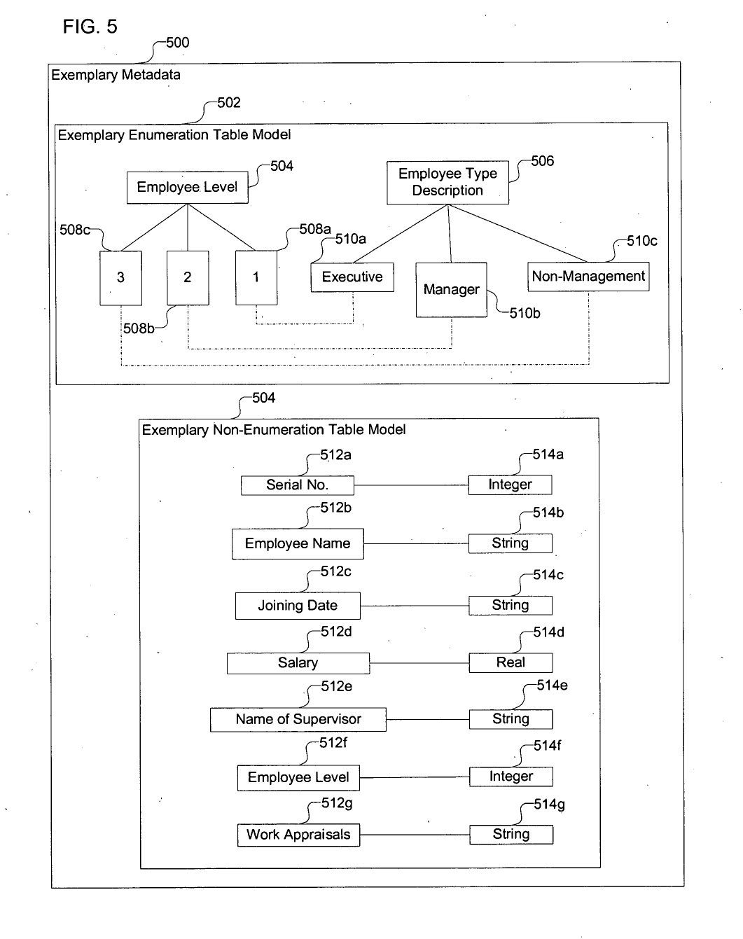

FIG. 5 illustrates exemplary metadata 500 generated by modeling enumeration tables 106a . . . 106n and other tables 108a . . . 108n in a database, in accordance with certain embodiments. In certain embodiments the exemplary metadata 500 is generated by the visual database modeling tool 110 by processing the exemplary enumeration table 304 and the exemplary non-enumeration table 302 shown in FIG. 3.

The exemplary metadata 500 includes an exemplary enumeration table model 502 that is a logical representation of the exemplary enumeration table 304 of FIG. 3. The elements employee level 504 and employee type description 506 correspond to the columns 316a, 316b of the exemplary enumeration table 304. The elements 1 (reference numeral 508a), 2 (reference numeral 508b), 3 (reference numeral 508d), “Executive” (reference numeral 510a), “Manager” (reference numeral 510b), and “Non-management” (reference numeral 510c) correspond to the entries in the rows 318a, 318b, 318c of the exemplary enumeration table. In certain embodiments the relationships between the elements 508a, 508b, 508c, 510a, 510b, 510c may also be modeled in the exemplary enumeration table model 502. Therefore, both rows and columns of an enumeration table are modeled in the exemplary enumeration table model 502.

The exemplary metadata 500 also includes an exemplary non-enumeration table model 504 that is a logical representation of the exemplary non-enumeration table 302 of FIG. 3. The elements Serial No. 512a, Employee Name 512b, Joining Date 512c, Salary 512d, Name of Supervisor 512e, Employee Level 512f, Work Appraisals 512g correspond to the columns 306a . . . 306g of the non-enumeration table 302. Additional elements 514a, 514b, 514c, 514d, 514d, 514f, 514g may indicate the data structures, such as integer, real, string, etc., used to represent the columns.

Therefore, FIG. 5 illustrates certain embodiments in which the exemplary enumeration table model 502 models both rows and columns of an exemplary enumeration table, whereas the exemplary non-enumeration table model 504 models the columns but not the rows of an exemplary non-enumeration table.

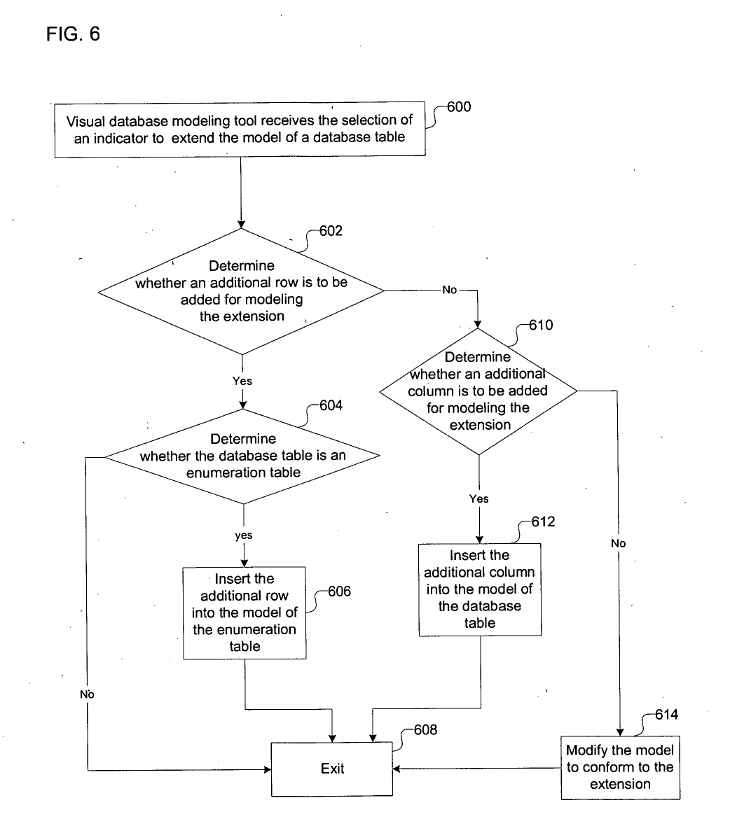

FIG. 6 illustrates a flowchart for inserting additional rows in the model 112 of an enumeration table, in accordance with certain embodiments. The operations illustrated in the flowchart of FIG. 6 may be implemented in the computational platform 102 by the visual database modeling tool 110.

Control starts at block 600, where the visual database modeling tool 110 receives the selection of an indicator to extend the model 112 of a database table. The model may have been previously generated by the operations illustrated in the flowchart of FIG. 4. The extension of the model may be potentially caused by the addition of a new row to a table, for example, a new employee level may have been added to the exemplary enumeration table 304.

The visual database modeling tool 110 determines (at block 602) whether an additional row is to be added for modeling the extension. If so, the visual modeling tool 110 determines (at block 604) whether the database table is an enumeration table. If the database table is an enumeration table, then the visual database modeling tool 110 inserts (at block 606) the additional row to the model 112 of the enumeration table and the process exits (at block 608). If the visual database modeling tool 110 determines (at block 604) that the database table is not an enumeration table, then the process exits (at block 608).

If the visual database modeling tool 110 determines (at block 602) that no additional row is to be added for modeling the extension, then the visual database modeling tool 110 determines (at block 610) whether an additional column is to be added to the model 112 for modeling the extension. If so, then the visual database modeling tool 110 inserts (at block 612) the additional column into the model 112 of the database table and the process exits (at block 608). If at block 610, the visual database modeling tool 110 determines that no additional column is to be added for modeling the extension, then the visual database modeling tool 110 modifies (at block 614) the model to conform to the extension before exiting (at block 608) the process.

Therefore, FIG. 6 illustrates certain embodiments in which an indicator in the visual database modeling tool is selected to insert additional rows into a modeled enumeration table.

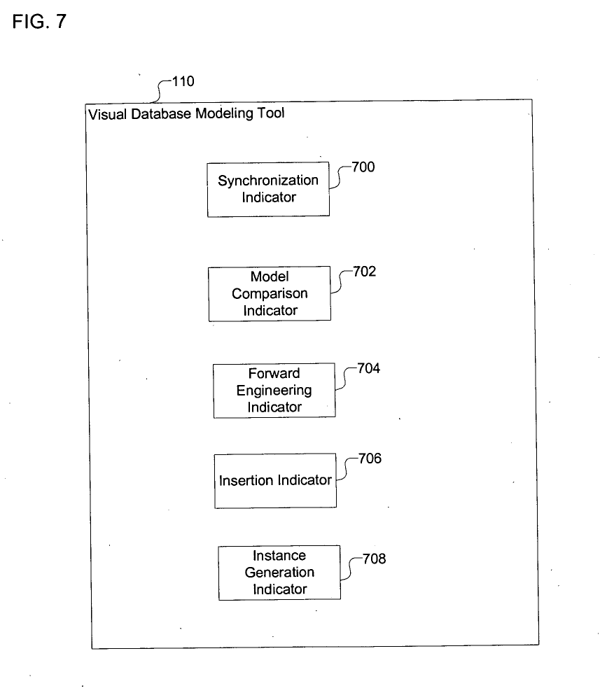

FIG. 7 illustrates certain indicators displayed by the visual database modeling tool 110, in accordance with certain embodiments.

Besides indicators already described earlier, the visual database modeling tool 110 may include code to display a synchronization indicator 700, a model comparison indicator 702, a forward engineering indictor 704, an insertion indictor 706, an instance generation indicator 708, etc. The indicators shown in FIG. 7 are illustrative, and other indicators may also be displayed by the visual database modeling tool 110. The indicators are visual cues provided to a user for performing particular functions.

In certain embodiments, there may be a change in the instance of an enumeration table modeled by the visual database modeling tool 110. A user may then select the synchronization indicator 700, and in response the visual database modeling tool 110 may synchronize the model 112 with the instance of the model, i.e., synchronize the model 112 with the enumeration table on which the model is based.

In certain embodiments, a user may select the model comparison indicator 702, and in response the visual database modeling tool 110 may compare the model of an enumeration table stored by the visual database modeling tool to an instance of the enumeration table stored in a database. The model comparison indicator 702 may be used to visually compare the metadata to the corresponding enumeration table.

In certain embodiments, a user may select the forward engineering indicator 704, and in response the visual database modeling tool 110 may generate the model 112 from an enumeration table. In certain embodiments, while forward engineering to generate a script corresponding to an enumeration table, a forward engineering component of the visual database modeling tool 110 may traverse an instance set to generate an insert data manipulation language statement for each instance after a data definition clause to create the script for the enumeration table.

In certain embodiments, a user may select the insertion indicator 706, and in response the visual database modeling tool 110 may insert additional rows into the model 112 of an enumeration table.

In certain embodiments, a user may select the instance generation indicator 708, and in response the visual database modeling tool 110 may use the model 112 to generate all instances of a table that is marked as an enumeration table.

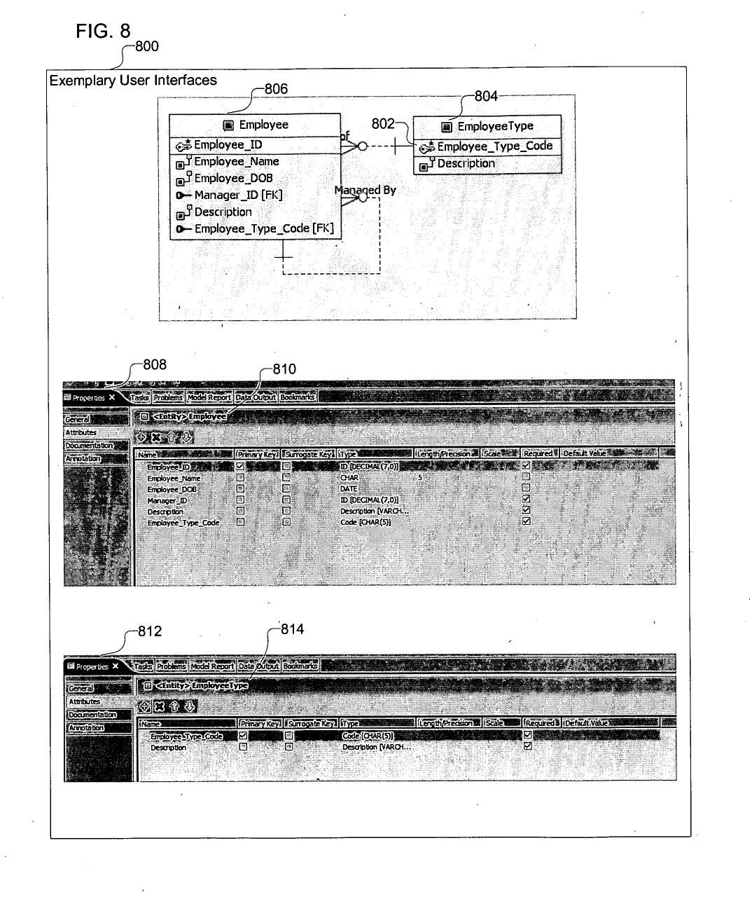

FIG. 8 illustrates certain exemplary user interfaces 800, in accordance with certain embodiments. The exemplary user interfaces 800 may be displayed by the visual database modeling tool 110 that has been implemented in the computing environment 100.

In the exemplary user interfaces 800, a visual indicator 802 has been included in EmployeeType 804 to indicate that EmployeeType 804 is an enumeration table that is different from Employee 806. An exemplary properties page 808 for the employee entity 810 and an exemplary properties page 812 for the EmployeeType entity 814 are also shown in the exemplary user interfaces 800.

In certain additional embodiments, in the exemplary properties page 808 for the employee entity 810, a Boolean property may be added to indicate whether a table (entity) is of enumeration type. If a Boolean property is added, there may be an additional property tab called “Instance” where a grid like interface that is similar to column/attribute tabs may be provided to allow users to enter row information.

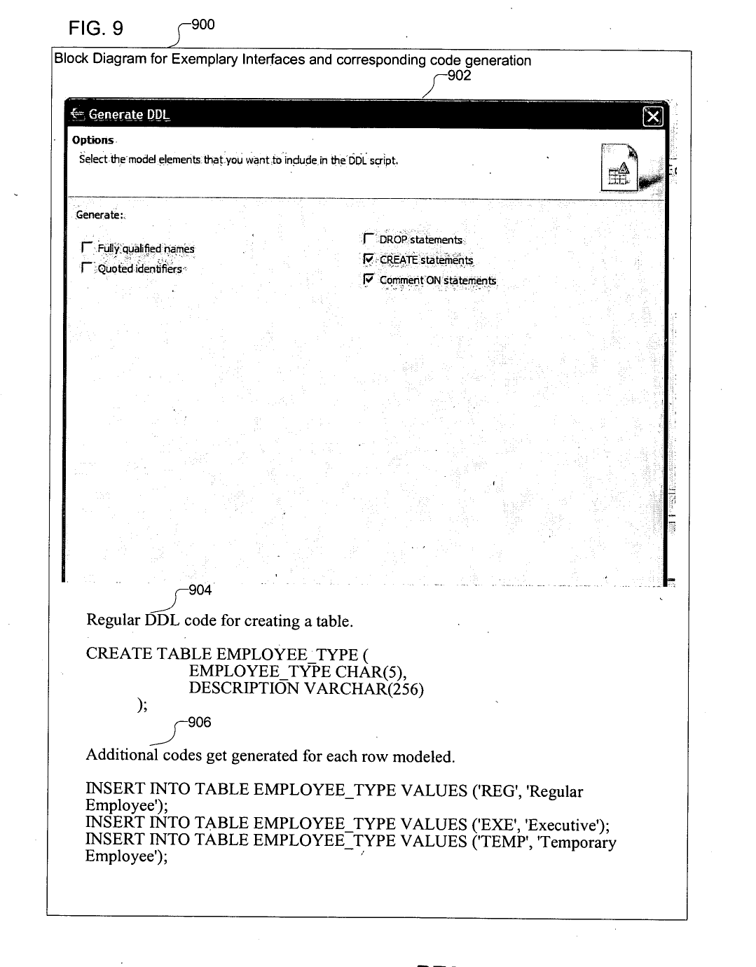

FIG. 9 illustrates a block diagram 900 that shows an exemplary user interface 902 for generating data definition language (DDL) code, in accordance with certain embodiments. The exemplary user interface 902 may be displayed by the visual database modeling tool 110 that has been implemented in the computing environment 100. The regular DDL code 904 for creating a table, and additional codes 906 that get generated for each row that is modeled are also shown in FIG. 9.

Certain embodiments provide a mechanism to model enumeration tables differently from tables that are not enumeration tables. If a table is an enumeration table, then both rows and columns for the table are modeled by a visual database modeling tool, whereas if the table is not an enumeration table then the rows of the table are not modeled by the visual database modeling tool.

In the case of enumeration tables, values of the domain known at design time are part of the metadata that is modeled by the visual database modeling tool 10. The visual database modeling tool 110 also provides support for instance modeling and instance roundtrip engineering. In certain embodiments SQL based metadata is extended to allow the instance modeling of a table such that the instances, i.e., rows, are modeled if the table is an enumeration table. The instance metadata is persisted as part of the metadata.

### Additional Embodiment Details

The described techniques may be implemented as a method, apparatus or article of manufacture involving software, firmware, micro-code; hardware and/or any combination thereof. The term “article of manufacture” as used herein refers to code or logic implemented in a medium, where such medium may comprise hardware logic [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. The term logic may include, by way of example, software, hardware, firmware, and/or combinations of these. Code in the computer readable medium is accessed and executed by a processor. The medium in which the code or logic is encoded may also comprise transmission signals propagating through space or a transmission media, such as an optical fiber, copper wire, etc. The transmission signal in which the code or logic is encoded may further comprise a wireless signal, satellite transmission, radio waves, infrared signals, Bluetooth, etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may comprise a combination of hardware and software components in which the code is embodied, processed, and executed. Of course, those skilled in the art will recognize that many modifications may be made without departing from the scope of embodiments, and that the article of manufacture may comprise any information bearing medium. For example, the article of manufacture comprises a storage medium having stored therein instructions that when executed by a machine results in operations being performed.

Certain embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, certain embodiments can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article. The functionality and/or the features of a device may be alternatively embodied by one or more other devices which are not explicitly described as having such functionality/features. Thus, other embodiments need not include the device itself.

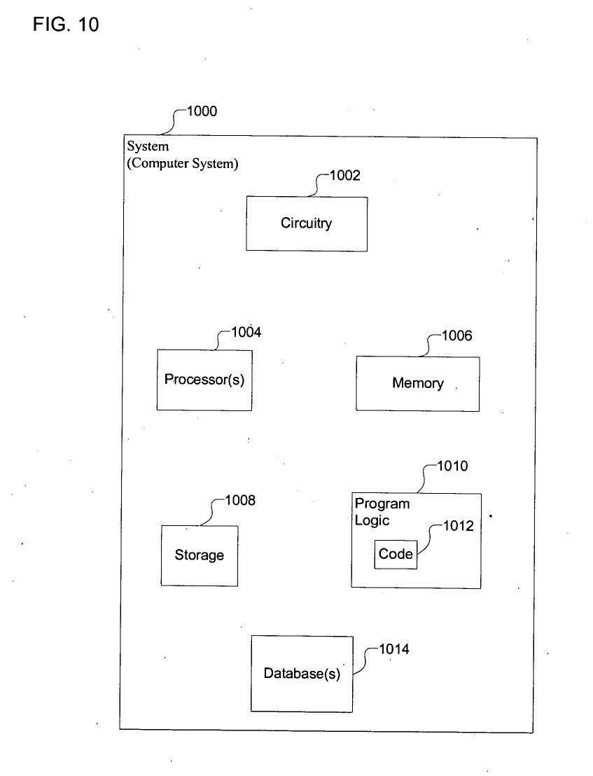

FIG. 10 illustrates a block diagram of the architecture of a system 1000 in which certain embodiments may be implemented. In certain embodiments, the computational platform 102 shown in FIG. 1, may be implemented in accordance with the system 1000. The system 1000 may include a circuitry 1002 that may in certain embodiments include a processor 1004. The system 1000 may also include a memory 1006 (e.g., a volatile memory device), and storage 1008. Certain elements of the system 1000 may or may not be found in the computational platform 102. The storage 1008 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 1008 may comprise an internal storage device, an attached storage device and/or a network accessible storage device. The system 1000 may include a program logic 1010 including code 1012 that may be loaded into the memory 1006 and executed by the processor 1004 or circuitry 1002. In certain embodiments, the program logic 1010 including code 1012 may be stored in the storage 1008. In certain other embodiments, the program logic 1010 may be implemented in the circuitry 1002. Therefore, while FIG. 10 shows the program logic 1010 separately from the other elements, the program logic 1010 may be implemented in the memory 1006 and/or the circuitry 1002. The system 1000 may also include one or more databases 1014, where the database management systems 104a . . . 104n implement the databases 1014, and where the databases 1014 may include a plurality of enumeration tables 106a, 106b, . . . ,106n and a plurality of other tables 108a, 108b, . . . , 108n that are not enumeration tables.

Certain embodiments may be directed to a method for deploying computing instruction by a person or automated processing integrating computer-readable code into a computing system, wherein the code in combination with the computing system is enabled to perform the operations of the described embodiments.

At least certain of the operations illustrated in FIGS. 4 and 6 may be performed in parallel as well as sequentially. In alternative embodiments, certain of the operations may be performed in a different order, modified or removed.

Furthermore, many of the software and hardware components have been described in separate modules for purposes of illustration. Such components may be integrated into a fewer number of components or divided into a larger number of components. Additionally, certain operations described as performed by a specific component may be performed by other components.

The data structures and components shown or referred to in FIGS. 1-10 are described as having specific types of information. In alternative embodiments, the data structures and components may be structured differently and have fewer, more, or different fields or different functions than those shown or referred to in the figures. Therefore, the foregoing description of the embodiments has been presented for the purposes of illustration and description. It is not intended to be exhaustive or to limit the embodiments to the precise form disclosed. Many modifications and variations are possible in light of the above teaching.

IBM, Rational and DB2 are trademarks or registered trademark of International Business Machines Corporation.

What is claimed is:

1. A method, comprising:
determining a table to be an enumeration table, in response to an indication provided to an application;
generating metadata corresponding to rows and columns of the enumeration table; and
maintaining a model that logically represents the enumeration table by storing the generated metadata.

2. The method of claim 1, wherein the rows of the enumeration table are fixed in number.

3. The method of claim 1, wherein the application is a visual database modeling tool, and wherein the determining of the table, the generating of the metadata, and the maintaining of the model, are performed by the visual database modeling tool.

4. The method of claim 3, wherein the indication is provided by a user to the visual database modeling tool by selecting an indicator that indicates a type of the table.

5. The method of claim 3, wherein the rows of the enumeration table correspond to instances and wherein the columns of the enumeration table are predetermined in number.

6. The method of claim 3, further comprising:
providing an indicator in the visual database modeling tool, wherein the indicator is selected to insert additional rows into the modeled enumeration table.

7. The method of claim 3, further comprising:
providing an indicator in the visual database modeling tool, wherein the indicator is selected to generate instances of the enumeration table from the modeled rows and columns of the enumeration table.

8. The method of claim 3, further comprising:
comparing the model of the enumeration table stored in the visual database modeling tool to an instance of the enumeration table stored in a database; and
synchronizing the model with the instance, in response to a change in the instance of the enumeration table that has been modeled by the visual database modeling tool.

9. An article of manufacture, wherein the article of manufacture stores instructions, and wherein the article of manufacture is operable to:
determine a table to be an enumeration table, in response to an indication provided to an application;
generate metadata corresponding to rows and columns of the enumeration table; and
maintain a model that logically represents the enumeration table by storing the generated metadata.

10. The article of manufacture of claim 9, wherein the rows of the enumeration table are fixed in number.

11. The article of manufacture of claim 9, wherein the application is a visual database modeling tool, and wherein the visual database modeling tool determines the table to be the enumeration table, generates the metadata, and maintains the model.

12. The article of manufacture of claim 11, wherein the indication is provided by a user to the visual database modeling tool by selecting an indicator that indicates a type of the table.

13. The article of manufacture of claim 11, wherein the rows of the enumeration table correspond to instances and wherein the columns of the enumeration table are predetermined in number.

14. The article of manufacture of claim 11, wherein the article of manufacture is further operable to:
provide an indicator in the visual database modeling tool, wherein the indicator is selected to insert additional rows into the modeled enumeration table.

15. The article of manufacture of claim 11, wherein the article of manufacture is further operable to:
provide an indicator in the visual database modeling tool, wherein the indicator is selected to generate instances of the enumeration table from the modeled rows and columns of the enumeration table.

16. The article of manufacture of claim 11, wherein the article of manufacture is further operable to:
compare the model of the enumeration table stored in the visual database modeling tool to an instance of the enumeration table stored in a database; and
synchronize the model with the instance, in response to a change in the instance of the enumeration table that has been modeled by the visual database modeling tool.

17. A system, comprising:
memory; and
logic coupled to the memory, wherein the logic is capable of causing operations to be performed, the operations comprising:
(i) determining a table to be an enumeration table, in response to an indication provided to an application;
(ii) generating metadata corresponding to rows and columns of the enumeration table; and
(iii) maintaining a model that logically represents the enumeration table by storing the generated metadata.

18. The system of claim 17, wherein the rows of the enumeration table are fixed in number.

19. The system of claim 17, wherein the application is a visual database modeling tool, and wherein the determining of the table, the generating of the metadata, and the maintaining of the model, are performed by the visual database modeling tool.

20. The system of claim 19, wherein the indication is provided by a user to the visual database modeling tool by selecting an indicator that indicates a type of the table.

21. The system of claim 19, wherein the rows of the enumeration table correspond to instances and wherein the columns of the enumeration table are predetermined in number.

22. The system of claim 19, the operations further comprising:
providing an indicator in the visual database modeling tool, wherein the indicator is selected to insert additional rows into the modeled enumeration table.

23. The system of claim 19, the operations further comprising:
providing an indicator in the visual database modeling tool, wherein the indicator is selected to generate instances of the enumeration table from the modeled rows and columns of the enumeration table.

24. The system of claim 19, the operations further comprising:
comparing the model of the enumeration table stored in the visual database modeling tool to an instance of the enumeration table stored in a database; and
synchronizing the model with the instance, in response to a change in the instance of the enumeration table that has been modeled by the visual database modeling tool.
